(19) United States
(12) Patent Application Publication
(10) Pub. No.: US 2008/0230938 A1
(43) Pub. Date: Sep. 25, 2008

(54) Moulded Part Comprising a Composite Layer Plate or Film and a Carrier Layer with an Improved Shine

(75) Inventors: Achim Grefenstein, Altrip (DE); Steffen Funkhauser, Viernheim (DE); Herbert Fisch, Wachenheim (DE); Norbert Effen, Lambsheim (DE)

Correspondence Address: CONNOLLY BOVE LODGE & HUTZ LLP, 1875 EYE STREET, N.W., SUITE 1100, WASHINGTON, DC, 20036, US

(73) Assignee: BASF Aktiengesellschaft, Ludwigshafen (DE)

(21) Appl. No.: 10/597,450

(22) PCT Filed: Jan. 27, 2005
(86) PCT No.: PCT/EP2005/000783

§ 371 Date: Jul. 26, 2006

(30) Foreign Application Priority Data
Jan. 29, 2004 (DE) 102004004694.8

(51) Int. Cl. B29C 47/06; B62D 29/04; B32B 27/12; B29C 44/00

(52) U.S. Cl. 264/45.1; 296/181.2; 428/301.4; 264/173.16; 264/173.1

(57) ABSTRACT

The invention relates to moldings, comprising a composite layered sheet or composite layered film, reverse-coated with a backing layer of plastic applied by an injection-molding, foaming, casting, or compression-molding method, where the composite layered sheet or composite layered film comprises
(1) a substrate layer comprising, based on the total of the amounts of components A and B, and, if appropriate, C and/or D, which give 100% by weight in total,
a from 1 to 99% by weight of an elastomeric graft copolymer as component A,
b from 1 to 99% by weight of one or more hard copolymers containing units which derive from vinylaromatic monomers, as component B,
c from 0 to 80% by weight of polycarbonates, as component C, and
d from 0 to 50% by weight of fibrous or particulate fillers, or a mixture of these, as component D, and
(3) a top layer composed of aliphatic thermoplastic polyurethane.

The invention further relates to processes for producing these moldings, to their use in the motor-vehicle-exterior sector, and to motor-vehicle-exterior parts.

The invention relates to moldings, comprising a composite layered sheet or composite layered film, reverse-coated with a backing layer of plastic applied by an injection-molding, foaming, casting, or compression-molding method, where the composite layered sheet or composite layered film comprises
(1) a substrate layer comprising, based on the total of the amounts of components A and B, and, if appropriate, C and/or D, which give 100% by weight in total,
a from 1 to 99% by weight of an elastomeric graft copolymer as component A,
b from 1 to 99% by weight of one or more hard copolymers containing units which derive from vinylaromatic monomers, as component B,
c from 0 to 80% by weight of polycarbonates, as component C, and
d from 0 to 50% by weight of fibrous or particulate fillers, or a mixture of these, as component D, and
(3) a top layer.

The invention further relates to processes for producing these moldings, to their use in the motor-vehicle-exterior sector, and to motor-vehicle-exterior parts.

When plastics are used outdoors, thus being exposed to environmental effects, such as weathering, temperature variations, or soiling, they are subject to stringent requirements, for example for mechanical and optical properties. Plastics moldings which comply with these requirements, at least for certain applications or periods of use, are known.

By way of example, DE 10228376.1 (file reference) describes moldings comprising a composite layered sheet or composite layered film reverse-coated with a backing layer of plastic applied by an injection-molding, foaming, or casting method, the moldings having good surface quality even at high temperatures, in particular a very low level of corrugation. The composite layered sheet or composite layered film in these moldings has a substrate layer which comprises, as hard copolymer component, polymers with high α-methylstyrene content. Suitable top layer materials disclosed for this composite layered sheet or composite layered film are weather-resistant, transparent, and scratch-resistant polymers, in particular polymethyl methacrylate, polycarbonate, or styrene-acrylonitrile copolymers. These moldings have good suitability for application in the motor vehicle bodywork sector. However, the surface gloss of these moldings decreases to an extent which is sometimes unsatisfactory during the course of their service life, for example through frequent soiling and the resultant necessary cleaning in automatic washing systems.

Aliphatic thermoplastic polyurethane is a polymer known to be useful in the motor vehicle sector. By way of example, “Farben im Licht” [Spotlight on colors], Kunststoffe 92 (2002) 6, pp. 93-95 discloses the particular properties of this material, such as light-fastness, low-temperature flexibility, good mechanical properties, resistance to aging, and scratch resistance which is better than that of the materials conventionally used, permitting use of automatic washing systems. Nothing is said concerning the change in surface gloss in the course of service life, for example through frequent soiling and the resultant necessary cleaning in automatic washing systems.

EP-B 567 883 discloses composite moldings composed of at least one layer of an ABS plastic and of at least one layer of a thermoplastic polyurethane with Shore D hardness >50. The composite moldings feature chemical resistance and thermoformability. Their use for producing refrigerator-interior containers is described. No applications in the outdoor sector or motor vehicle sector are described.

It is an object of the present invention to provide moldings comprising a composite layered sheet or composite layered film reverse-coated with a backing layer of plastic applied by an injection-molding, foaming, casting, or compression-molding method, with improved surface gloss over the service life, in particular in association with frequent soiling and the resultant necessary cleaning in automatic washing systems.

The invention achieves the object by way of moldings comprising a composite layered sheet or composite layered film, reverse-coated with a backing layer of plastic applied by an injection-molding, foaming, casting, or compression-molding method, where the composite layered sheet or composite layered film comprises
(1) a substrate layer comprising, based on the total of the amounts of components A and B, and, if appropriate, C and/or D, which give 100% by weight in total,
a from 1 to 99% by weight of an elastomeric graft copolymer as component A,
b from 1 to 99% by weight of one or more hard copolymers containing units which derive from vinylaromatic monomers, as component B,
c from 0 to 80% by weight of polycarbonates, as component C, and d from 0 to 50% by weight of fibrous or particulate fillers, or a mixture of these, as component D, and
(3) a top layer composed of aliphatic thermoplastic polyurethane.

The inventive moldings have improved surface gloss over their service life, in particular in association with frequent soiling and the resultant necessary cleaning in automatic washing systems. They are therefore particularly suitable for the outdoor sector where they are exposed to environmental effects such as weathering, temperature variations, or soiling, for example as motor-vehicle-exterior parts.

The individual layers or components of the moldings and of the composite layered sheets or composite layered films present therein are described below.

### Layer (1)

Layer (1) is composed of the following components A and B, and, if appropriate, C and/or D, which give a total of 100% by weight.

The substrate layer (1) comprises impact-modified copolymers of vinylaromatic monomers with vinyl cyanides (SAN), and also, if appropriate, comprises other components, preferably polycarbonate.

The impact-modified SAN used is preferably ASA polymers and/or ABS polymers.

ASA polymers are generally understood to mean impact-modified SAN polymers in which graft copolymers of vinylaromatic compounds, in particular styrene, with vinyl cyanides, in particular acrylonitrile, are present on polyalkyl acrylate rubbers in a copolymer matrix in particular of styrene and/or α-methylstyrene and acrylonitrile.

In one preferred embodiment in which the substrate layer (1) comprises ASA polymers, component A is an elastomeric graft copolymer made from
a1 from 1 to 99% by weight, preferably from 55 to 80% by weight, in particular from 55 to 65% by weight, of a particulate graft base A1 with a glass transition temperature below 0° C.,
a2 from 1 to 99% by weight, preferably from 20 to 45% by weight, in particular from 35 to 45% by weight, of a graft A2 made from the following monomers, based on A2,
a21 from 40 to 100% by weight, preferably from 65 to 85% by weight, of units of styrene, of a substituted styrene, or of a (meth)acrylate, or of a mixture of these, in particular of styrene and/or α-methylstyrene, as component A21, and
a22 up to 60% by weight, preferably from 15 to 35% by weight, of units of acrylonitrile or methacrylonitrile, in particular of acrylonitrile, as component A22.

The graft A2 here is composed of at least one graft shell, and the graft copolymer A has a total average particle size of from 50 to 1000 nm.

Component A1 here is composed of the following monomers
a11 from 80 to 99.99% by weight, preferably from 95 to 99.9% by weight, of at least one C₁-C₈-alkyl acrylate, preferably n-butyl acrylate and/or ethylhexyl acrylate, as component A11,
a12 from 0.01 to 20% by weight, preferably from 0.1 to 5.0% by weight, of at least one polyfunctional crosslinking monomer, preferably diallyl phthalate and/or DCPA, as component A12.

In one embodiment of the invention, the average particle size of component A is from 50 to 800 nm, preferably from 50 to 600 nm.

In another embodiment of the invention, the particle size distribution of component A is bimodal, from 60 to 90% by weight having a average particle size of from 50 to 200 nm, and from 10 to 40% by weight having an average particle size of from 50 to 400 nm, based on the total weight of component A.

The average particle size and particle size distribution given are the sizes determined from the cumulative weight distribution. The average particle sizes according to the invention are in all cases the weight average of the particle sizes. The determination of these is based on the method of W. Scholtan and H. Lange, Kolloid-Z. und Z.-Polymere 250 (1972), pp. 782-796, using an analytical ultracentrifuge. The ultracentrifuge measurement gives the cumulative weight distribution of the particle diameter of a specimen. From this it is possible to deduce what percentage by weight of the particles have a diameter identical to or smaller than a particular size. The average particle diameter, which is also termed the d₅₀ of the cumulative weight distribution, is defined here as that particle diameter at which 50% by weight of the particles have a diameter smaller than that corresponding to the d₅₀. Equally, 50% by weight of the particles then have a larger diameter than the d₅₀. To describe the breadth of the particle size distribution of the rubber particles, d₁₀ and d₉₀ values given by the cumulative weight distribution are utilized alongside the d₅₀ value (average particle diameter). The d₁₀ and d₉₀ of the cumulative weight distribution are defined similarly to the d₅₀ with the difference that they are based on, respectively, 10 and 90% by weight of the particles. The quotient

(d₉₀−d₁₀)/d₅₀=Q

is a measure of the breadth of the particle size distribution. Emulsion polymers A which can be used according to the invention as component A preferably have Q less than 0.5, in particular less than 0.35.

The acrylate rubbers A1 are preferably alkyl acrylate rubbers made from one or more C₁-C₈-alkyl acrylates, preferably C₄-C₈-alkyl acrylates, preferably with use of at least some butyl, hexyl, octyl or 2-ethylhexyl acrylate, in particular n-butyl and 2-ethylhexyl acrylate. These alkyl acrylate rubbers may contain, as comonomers, up to 30% by weight of hard-polymer-forming monomers, such as vinyl acetate, (meth)acrylonitrile, styrene, substituted styrene, methyl methacrylate, vinyl ether.

The acrylate rubbers also contain from 0.01 to 20% by weight, preferably from 0.1 to 5% by weight, of crosslinking, polyfunctional monomers (crosslinking monomers). Examples of these are monomers which contain two or more double bonds capable of copolymerization, preferably not 1,3-conjugated.

Examples of suitable crosslinking monomers are divinylbenzene, diallyl maleate, diallyl fumarate, diallyl phthalate, diethyl phthalate, triallyl cyanurate, triallyl isocyanurate, tricyclodecenyl acrylate, dihydrodicyclopentadienyl acrylate, triallyl phosphate, allyl acrylate, allyl methacrylate. Dicyclopentadienyl acrylate (DCPA) has proven to be a particularly suitable crosslinking monomer (cf. DE-C 12 60 135).

Component A is a graft copolymer. These graft copolymers A have an average particle size d₅₀ of from 50 to 1000 nm, preferably from 50 to 800 nm, and particularly preferably from 50 to 600 nm. These particle sizes may be achieved if the graft base A1 used for this component A has a particle size of from 50 to 350 nm, preferably from 50 to 300 nm, and particularly preferably from 50 to 250 nm.

The graft copolymer A generally has one or more stages, i.e. is a polymer composed of a core and one or more shells. The polymer is composed of a first stage (graft core) A1 and of one or—preferably—more stages A2 (grafts) grafted onto this first stage and known as graft stages or graft shells.

Simple grafting or multiple stepwise grafting may be used to apply one or more graft shells to the rubber particles, and each of these graft shells may have a different makeup. In addition to the monomers to be grafted, polyfunctional crosslinking monomers or monomers containing reactive groups may also be included in the grafting (see, for example, EP-A 230 282, DE-B 36 01 419, EP-A 269 861).

In one preferred embodiment, component A is composed of a graft copolymer built up in two or more stages, the graft stages generally being prepared from resin-forming monomers and having a glass transition temperature T_{g} above 30° C., preferably above 50° C. The structure having two or more stages serves, inter alia, to make the rubber particles A (partially) compatible with the thermoplastic B.

An example of a preparation method for graft copolymers A is grafting of at least one of the monomers A2 listed below onto at least one of the graft bases or graft core materials A1 listed above.

In one embodiment of the invention, the graft base A1 is composed of from 15 to 99% by weight of acrylate rubber, from 0.1 to 5% by weight of crosslinker, and from 0 to 49.9% by weight of one of the stated other monomers or rubbers.

Suitable monomers for forming the graft A2 are styrene, α-methylstyrene, (meth)acrylates, acrylonitrile, and methacrylonitrile, in particular acrylonitrile.

In one embodiment of the invention, crosslinked acrylate polymers with a glass transition temperature below 0° C. serve as graft base A1. The crosslinked acrylate polymers are preferably to have a glass transition temperature below −20° C., in particular below −30° C.

In one preferred embodiment, the graft A2 is composed of at least one graft shell, and the outermost graft shell of these has a glass transition temperature of more than 30° C., while a polymer formed from the monomers of the graft A2 would have a glass transition temperature of more than 80° C.

Suitable preparation processes for graft copolymers A are emulsion, solution, bulk, or suspension polymerization. The graft copolymers A are preferably prepared by free-radical emulsion polymerization in the presence of latices of component A1 at from 20° C. to 90° C., using water-soluble or oil-soluble initiators, such as peroxodisulfate or benzoyl peroxide, or with the aid of redox initiators. Redox initiators are also suitable for polymerization below 20° C.

Suitable emulsion polymerization processes are described in DE-A 28 26 925, 31 49 358, and DE-C 12 60 135.

The graft shells are preferably built up in the emulsion polymerization process described in DE-A 32 27 555, 31 49 357, 31 49 358, 34 14 118. The defined setting of the particle sizes of the invention of from 50 to 1000 nm preferably takes place by the processes described in DE-C 12 60 135 and DE-A 28 26 925, and Applied Polymer Science, volume 9 (1965), p. 2929. The use of polymers with different particle sizes is known from DE-A 28 26 925 and US-A 5 196 480, for example.

The process described in DE-C 12 60 135 begins by preparing the graft base A1 by polymerizing in a known manner, at from 20 to 100° C., preferably from 50 to 80° C., the acrylate(s) used in one embodiment of the invention and the polyfunctional crosslinking monomer, if appropriate together with the other comonomers, in aqueous emulsion. Use may be made of the usual emulsifiers, such as alkali metal alkyl- or alkylarylsulfonates, alkyl sulfates, fatty alcohol sulfonates, salts of higher fatty acids having from 10 to 30 carbon atoms or resin soaps. It is preferable to use the sodium salts of alkylsulfonates or fatty acids having from 10 to 18 carbon atoms. In one embodiment, the amounts used of the emulsifiers are from 0.5 to 5% by weight, in particular from 1 to 2% by weight, based on the monomers used in preparing the graft base A1. Operations are generally carried out with a ratio of water to monomers of from 2:1 to 0.7:1 by weight. The polymerization initiators used are in particular the commonly used persulfates, such as potassium persulfate. However, it is also possible to use redox systems. The amounts generally used of the initiators are from 0.1 to 1% by weight, based on the monomers used in preparing the graft base A1. Other polymerization auxiliaries which may be used during the polymerization are the usual buffer substances which can set a preferred pH of from 6 to 9, examples being sodium bicarbonate and sodium pyrophosphate, and also from 0 to 3% by weight of a molecular weight regulator, such as mercaptans, terpinols or dimeric α-methylstyrene.

The precise polymerization conditions, in particular the nature, feed parameters, and amount of the emulsifier, are determined individually within the ranges given above in such a way that the resultant latex of the crosslinked acrylate polymer has a d₅₀ in the range from about 50 to 1000 nm, preferably from 50 to 600 nm, particularly preferably in the range from 80 to 500 nm. The particle size distribution of the latex here is intended to be narrow.

In a subsequent step, polymerization of a monomer mixture made from styrene and acrylonitrile in the presence of the resultant latex of the crosslinked acrylate polymer in one embodiment of the invention is carried out to prepare the graft polymer A, where in one embodiment of the invention the weight ratio of styrene to acrylonitrile in the monomer mixture should be in the range from 100:0 to 40:60, and preferably from 65:35 to 85:15. This graft copolymerization of styrene and acrylonitrile onto the crosslinked polyacrylate polymer serving as a graft base is again advantageously carried out in aqueous emulsion under the usual conditions described above. The graft copolymerization may usefully take place in the system used for the emulsion polymerization to prepare the graft base A1, where further emulsifier and initiator may be added if necessary. The mixture of styrene and acrylonitrile monomers which is to be grafted on in one embodiment of the invention may be added to the reaction mixture all at once, in portions in more than one step, or preferably continuously during the course of the polymerization. The graft copolymerization of the mixture of styrene and acrylonitrile in the presence of the crosslinking acrylate polymer is carried out in such a way as to obtain in graft copolymer A a degree of grafting of from 1 to 99% by weight, preferably from 20 to 45% by weight, in particular from 35 to 45% by weight, based on the total weight of component A. Since the grafting yield in the graft copolymerization is not 100% the amount of the mixture of styrene and acrylonitrile monomers which has to be used in the graft copolymerization is somewhat greater than that which corresponds to the desired degree of grafting. Control of the grafting yield in the graft copolymerization, and therefore of the degree of grafting of the finished graft copolymer A, is a topic with which the person skilled in the art is familiar. It may be achieved, for example, via the metering rate of the monomers or via addition of regulators (Chauvel, Daniel, ACS Polymer Preprints 15 (1974), pp. 329 ff.). The emulsion graft copolymerization generally gives approximately 5 to 15% by weight, based on the graft copolymer, of free, ungrafted styrene-acrylonitrile copolymer. The proportion of the graft copolymer A in the polymerization product obtained in the graft copolymerization is determined by the method given above.

Preparation of the Graft Copolymers a by the Emulsion Process Also Gives, Besides the technical process advantages stated above, the possibility of reproducible changes in particle sizes, for example by agglomerating the particles at least to some extent to give larger particles. This implies that polymers with different particle sizes may also be present in the graft copolymers A.

Component A made from graft base and graft shell(s) can in particular be ideally adapted to the respective application, in particular with regard to particle size.

The graft copolymers A generally comprise from 1 to 99% by weight, preferably from 55 to 80% by weight, and particularly preferably from 55 to 65% by weight, of graft base A1 and from 1 to 99% by weight, preferably from 20 to 45% by weight, particularly preferably from 35 to 45% by weight, of the graft A2, based in each case on the entire graft copolymer.

ABS polymers are generally understood to be impact-modified SAN polymers in which diene polymers, in particular poly-1,3-butadiene, are present in a copolymer matrix, in particular of styrene and/or α-methylstyrene, and acrylonitrile.

In one preferred embodiment, in which the substrate layer (1) comprises ABS polymers, component A is an elastomeric graft copolymer made from
a1′ from 10 to 90% by weight of at least one elastomeric graft base with a glass transition temperature below 0° C., obtainable by polymerizing, based on A1′,
a11′ from 60 to 100% by weight, preferably from 70 to 100% by weight, of at least one conjugated diene and/or C₁-C₁₀-alkyl acrylate, in particular butadiene, isoprene, n-butyl acrylate and/or 2-ethylhexyl acrylate,
a12′ from 0 to 30% by weight, preferably from 0 to 25% by weight, of at least one other monoethylenically unsaturated monomer, in particular styrene, α-methylstyrene, n-butyl acrylate, methyl methacrylate, or a mixture of these, and among the last-named in particular butadiene-styrene copolymers and n-butyl acrylate-styrene copolymers, and
a13′ from 0 to 10% by weight, preferably from 0 to 6% by weight, of at least one cross-linking monomer, preferably divinylbenzene, diallyl maleate, allyl (meth)acrylate, dihydrodicyclopentadienyl acrylate, divinyl esters of dicarboxylic acids, such as succinic and adipic acid, and diallyl and divinyl ethers of bifunctional alcohols, such as ethylene glycol or butane-1,4-diol,
a2′ from 10 to 60% by weight, preferably from 15 to 55% by weight, of a graft A2′, made from, based on A2′,
a21′ from 50 to 100% by weight, preferably from 55 to 90% by weight, of at least one vinylaromatic monomer, preferably styrene and/or α-methylstyrene,
a22′ from 5 to 35% by weight, preferably from 10 to 30% by weight, of acrylonitrile and/or methacrylonitrile, preferably acrylonitrile,
a23′ from 0 to 50% by weight, preferably from 0 to 30% by weight, of at least one other monoethylenically unsaturated monomer, preferably methyl methacrylate and n-butyl acrylate.

In another preferred embodiment in which layer (1) comprises ABS, component A is a graft rubber with bimodal particle size distribution, made from, based on A,
a1″ from 40 to 90% by weight, preferably from 45 to 85% by weight, of an elastomeric particulate graft base A1″, obtainable by polymerizing, based on A1″,
a11″ from 70 to 100% by weight, preferably from 75 to 100% by weight, of at least one conjugated diene, in particular butadiene and/or isoprene,
a12″ from 0 to 30% by weight, preferably from 0 to 25% by weight, of at least one other monoethylenically unsaturated monomer, in particular styrene, α-methylstyrene, n-butyl acrylate, or a mixture of these,
a2″ from 10 to 60% by weight, preferably from 15 to 55% by weight, of a graft A2″ made from, based on A2″,
a21″ from 65 to 95% by weight, preferably from 70 to 90% by weight, of at least one vinylaromatic monomer, preferably styrene,
a22″ from 5 to 35% by weight, preferably from 10 to 30% by weight, of acrylonitrile,
a23″ from 0 to 30% by weight, preferably from 0 to 20% by weight, of at least one other monoethylenically unsaturated monomer, preferably methyl methacrylate and n-butyl acrylate.

### Component B

In one preferred embodiment in which the substrate layer (1) comprises ASA polymers, component B is at least one hard copolymer which contains units which derive from vinylaromatic monomers, and containing, based on the total weight of units deriving from vinylaromatic monomers, from 0 to 100% by weight, preferably from 40 to 100% by weight, particularly preferably from 60 to 100% by weight, of units deriving from α-methylstyrene, and containing from 0 to 100% by weight, preferably from 0 to 60% by weight, particularly preferably from 0 to 40% by weight, of units deriving from styrene, made from
b1 from 40 to 100% by weight, preferably from 60 to 85% by weight, of vinylaromatic units, as component B1,
b2 up to 60% by weight, preferably from 15 to 40% by weight, of units of acrylonitrile or of methacrylonitrile, in particular of acrylonitrile, as component B2.

In one preferred embodiment, in which the substrate layer (1) comprises ABS polymers, component B is at least one hard copolymer which contains units which derive from vinylaromatic monomers, and containing, based on the total weight of units deriving from vinylaromatic monomers, from 0 to 100% by weight, preferably from 40 to 100% by weight, particularly preferably from 60 to 100% by weight, of units deriving from α-methylstyrene, and from 0 to 100% by weight, preferably from 0 to 60% by weight, particularly preferably from 0 to 40% by weight, of units deriving from styrene, made from, based on B,
b1′ from 50 to 100% by weight, preferably from 55 to 90% by weight, of vinylaromatic monomers,
b2′ from 0 to 50% by weight of acrylonitrile or methacrylonitrile or a mixture of these,
b3′ from 0 to 50% by weight of at least one other monoethylenically unsaturated monomer, such as methyl methacrylate and N-alkyl- or N-arylmaleimides, e.g. N-phenylmaleimide.

In another preferred embodiment in which layer (1) comprises ABS, component B is at least one hard copolymer with a viscosity number VN (determined to DIN 53726 at 25° C. in 0.5% strength by weight solution in dimethylformamide) of from 50 to 120 ml/g, containing units which derive from vinylaromatic monomers, and containing, based on the total weight of units deriving from vinylaromatic monomers, from 0 to 100% by weight, preferably from 40 to 100% by weight, particularly preferably from 60 to 100% by weight, of units deriving from α-methylstyrene, and from 0 to 100% by weight, preferably from 0 to 60% by weight, particularly preferably from 0 to 40% by weight, of units deriving from styrene, made from, based on B,
b1″ from 69 to 81% by weight, preferably from 70 to 78% by weight, of vinylaromatic monomers,
b2″ from 19 to 31% by weight, preferably from 22 to 30% by weight, of acrylonitrile,
b3″ from 0 to 30% by weight, preferably from 0 to 28% by weight, of at least one other monoethylenically unsaturated monomer, such as methyl methacrylate and N-alkyl- or N-arylmaleimides, e.g. N-phenylmaleimide.

In one embodiment, the ABS polymers comprise, alongside one another, components B whose viscosity numbers VN differ by at least 5 units (ml/g) and/or whose acrylonitrile contents differ by five units (% by weight). Finally, besides the component B in the other embodiments there may also be copolymers present of α-methylstyrene with maleic anhydride or maleimides, of α-methylstyrene with maleimides and methyl methacrylate or acrylonitrile, or of α-methylstyrene with maleimides, methyl methacrylate, and acrylonitrile.

In the case of these ABS polymers, the graft polymers A are preferably obtained by emulsion polymerization. The mixing of the graft polymers A with components B and, if appropriate, other additives takes place in a mixing apparatus, producing a substantially molten polymer mixture. It is advantageous for the molten polymer mixture to be cooled very rapidly.

The German Patent Application DE-A 19728629, expressly incorporated herein by way of reference, also gives a detailed description of the preparation of the above-mentioned ABS polymers and of both general and specific embodiments of these polymers.

The ABS polymers mentioned may comprise other conventional auxiliaries and fillers. Examples of these materials are lubricants, mold-release agents, waxes, pigments, dyes, flame retardants, antioxidants, light stabilizers, and antistats.

In one particular embodiment of the invention, the viscosity number of component B is from 50 to 90, preferably from 60 to 80.

Component B is preferably an amorphous polymer. In one embodiment of the invention, the component B used comprises a mixture of a copolymer of styrene with acrylonitrile and a copolymer of α-methylstyrene with acrylonitrile. The acrylonitrile content in these copolymers of component B is from 0 to 60% by weight, preferably from 15 to 40% by weight, based on the total weight of component B. Component B also includes the free, ungrafted α-methylstyrene-acrylonitrile copolymers produced during the graft copolymerization to prepare component A. Depending on the conditions selected during the graft copolymerization for preparing the graft copolymer A, it can be possible for a sufficient proportion of component B to be formed before the graft copolymerization has ended. However, it is generally necessary to blend the products obtained during the graft copolymerization with additional, separately prepared component B.

This additional, separately prepared component B may preferably be a mixture of styrene-acrylonitrile copolymer with an α-methylstyrene-acrylonitrile copolymer, or may be an α-methylstyrene-styrene-acrylonitrile terpolymer. These copolymers may be used for component B either as individual polymers or else as a mixture, and therefore the additional, separately prepared component B may be, for example, a mixture of a styrene-acrylonitrile copolymer with an α-methylstyrene-acrylonitrile copolymer. In the event that component B is composed of a mixture of a styrene-acrylonitrile copolymer with an α-methylstyrene-acrylonitrile copolymer, the acrylonitrile contents of the two copolymers should preferably differ from one another by not more than 10% by weight, preferably not more than 5% by weight, based on the total weight of the copolymer.

The additional, separately prepared component B may be obtained by the conventional processes. In one embodiment of the invention, therefore, the copolymerization of the styrene and/or α-methylstyrene with the acrylonitrile may be carried out in bulk, solution, suspension or aqueous emulsion. Component B preferably has a viscosity number of from 40 to 100, preferably from 50 to 90, in particular from 60 to 80. The viscosity number is determined here in accordance with DIN 53 726, by dissolving 0.5 g of material in 100 ml of dimethylformamide.

Components A and B and, if appropriate, C and D, may be mixed in any desired manner using any of the known methods. If, for example, components A and B have been prepared by emulsion polymerization, the polymer dispersions obtained may be mixed with one another, the polymers then precipitated together and the polymer mixture worked up. However, the blending of components A and B preferably takes place by extruding, kneading or rolling the components together. If required, the components have previously been isolated from the aqueous dispersion or solution obtained in the polymerization. The products of the graft copolymerization (component A) which have been obtained in aqueous dispersion may also be only partly dewatered and mixed in the form of moist crumbs with component B. In this case the complete drying of the graft copolymers takes place during the mixing.

In one preferred embodiment, the layer (1) comprises additional components C and/or D besides components A and B, and also, if appropriate, other additives, as described below.

### Component C

In principle, any of the polycarbonates known per se or available commercially is suitable as component C. The polycarbonates suitable as component C preferably have a molar mass (weight average M_{W}, determined using gel permeation chromatography in tetrahydrofuran against polystyrene standards) in the range from 10 000 to 60 000 g/mol. They are obtainable, for example, by the processes of DE-B-1 300 266 by interfacial polycondensation or by the process of DE-A-1 495 730 by reacting diphenyl carbonate with bisphenols. A preferred bisphenol is 2,2-di(4-hydroxyphenyl)propane, referred to generally, and also below, as bisphenol A.

Instead of bisphenol A use may also be made of other aromatic dihydroxy compounds, in particular 2,2-di(4-hydroxyphenyl)pentane, 2,6-dihydroxynaphthalene, 4,4′-dihydroxydiphenyl sulfone, 4,4′-dihydroxydiphenyl ether, 4,4′-dihydroxydiphenyl sulfite, 4,4′-dihydroxydiphenylmethane, 1,1-di(4-hydroxyphenyl)ethane, 4,4-dihydroxydiphenyl or dihydroxydiphenylcycloalkanes, preferably dihydroxydiphenylcyclohexanes or dihydroxycyclopentanes, in particular 1,1-bis(4-hydroxyphenyl)-3,3,5-trimethylcyclohexane, or also mixtures of the abovementioned dihydroxy compounds.

Particularly preferred polycarbonates are those based on bisphenol A or bisphenol A together with up to 80 mol % of the abovementioned aromatic dihydroxy compounds.

Polycarbonates particularly highly suitable as component C are those containing units which derive from resorcinol esters or from alkylresorcinol esters, for example as described in WO 00/61664, WO 00/15718, or WO 00/26274. Polycarbonates of this type are marketed by General Electric Company with the trademark SollX8, for example.

It is also possible to use copolycarbonates of U.S. Pat. No. 3,737,409. Copolycarbonates based on bisphenol A and di(3,5-dimethyldihydroxyphenyl) sulfone are of particular interest here and have high heat resistance. It is also possible to use mixtures of different polycarbonates.

According to the invention, the average molar masses (weight average M_{W} determined with the aid of gel permeation chromatography in tetrahydrofuran against polystyrene standards) of the polycarbonates C are in the range from 10 000 to 64 000 g/mol. They are preferably in the range from 15 000 to 63 000 g/mol, in particular from 15 000 to 60 000 g/mol. This implies that the polycarbonates C have relative solution viscosities, measured in 0.5% strength by weight solution in dichloromethane at 25° C., in the range from 1.1 to 1.3, preferably from 1.15 to 1.33. The relative solution viscosities of the polycarbonates used preferably do not differ by more than 0.05, in particular not by more than 0.04.

The polycarbonates C may be used either as ground material or as pellets. They are present as component C in amounts of from 0 to 80% by weight, preferably from 20 to 70% by weight, particularly preferably from 40 to 70% by weight, based in each case on the entirety of components A, B, C, and, if appropriate, D.

Addition of polycarbonates leads, inter alia, to greater thermal stability and improved cracking resistance of the sheets, films, and moldings.

### Component D

Component D layer (1) is present in from 0 to 50% by weight, preferably from 0 to 40% by weight, in particular from 0 to 30% by weight, of fibrous or particulate fillers or a mixture of these, based in each case on the entire layer 1. These are preferably commercially available products.

Reinforcing agents, such as carbon fibers and glass fibers, are usually used in amounts of from 5 to 50% by weight, based on the entire layer (1).

The glass fibers used may be made from E, A or C glass and have preferably been provided with a size and with a coupling agent. Their diameter is generally from 6 to 20 μm. Use may be made either of continuous-filament fibers (rovings) or of chopped glass fibers (staple) whose length is from 1 to 10 mm, preferably from 3 to 6 mm.

It is also possible to add fillers or reinforcing substances such as glass beads, mineral fibers, whiskers, alumina fibers, mica, powdered quartz and wollastonite.

In addition, metal flakes (e.g. aluminum flakes from Transmet Corp.), metal powders, metal fibers, metal-coated fillers, e.g. nickel-coated glass fibers, and also other additives which screen electromagnetic waves, may be added. Aluminum flakes (K 102 from Transmet) are particularly suitable for EMI (electromagnetic interference) purposes. The compositions may also be mixed with additional carbon fibers, carbon black, in particular conductivity black, or nickel-coated carbon fibers.

The layer (1) used according to the invention may moreover comprise other additives which are typical and commonly used for polycarbonates, SAN polymers, and graft copolymers, or for mixtures of these. Examples which may be mentioned of these additives are: dyes, pigments, colorants, antistats, antioxidants, stabilizers for improving thermal stability, for increasing photostability and for raising hydrolysis resistance and chemicals resistance, agents to counteract thermal decomposition, and in particular the lubricants useful for producing moldings. These other additives may be metered in at any stage of the production process, but preferably at an early juncture in order to make early use of the stabilizing effects (or other specific effects) of the additive. Heat stabilizers or oxidation inhibitors are usually metal halides (chlorides, bromides or iodides) derived from metals of Group I of the Periodic Table of the Elements (for example Li, Na, K or Cu).

Other suitable stabilizers are the usual hindered phenols, or else vitamin E and/or compounds of similar structure. HALS stabilizers (hindered amine light stabilizers), benzophenones, resorcinols, salicylates, benzotriazoles such as TinuvinRP (UV absorber 2-(2H-benzotriazol-2-yl)-4-methylphenol from CIBA) and other compounds are also suitable. These are usually used in amounts of up to 2% by weight (based on the entire mixture).

Suitable lubricants and mold-release agents are stearic acids, stearyl alcohol, stearates and/or higher fatty acids in general, derivatives of these and corresponding fatty acid mixtures having from 12 to 30 carbon atoms. The amounts of these additions are in the range from 0.05 to 1% by weight.

Other possible additives are silicone oils, oligomeric isobutylene or similar substances, usually in amounts of from 0.05 to 5% by weight. It is also possible to use pigments, dyes and color brighteners, such as ultramarine blue, phthalocyanines, titanium dioxide, cadmium sulfides and derivatives of perylenetetracarboxylic acid.

Processing aids and stabilizers, such as UV stabilizers, lubricants and antistats, are usually used in amounts of from 0.01 to 5% by weight.

The layer (1) may be produced by processes known per se, by mixing the components. It can be advantageous to premix individual components. It is also possible to mix the components in solution and remove the solvents.

Examples of suitable organic solvents are chlorobenzene, mixtures of chlorobenzene and methylene chloride, and mixtures made from chlorobenzene or from aromatic hydrocarbons, e.g. toluene.

An example of the method of evaporating the solvent mixtures is to use vented extruders.

Any of the known mixing methods may be used to mix the, for example dry, components. However, the mixing preferably takes place by extruding, kneading, or rolling the components together, preferably at from 180 to 400° C., the components having been isolated in advance if necessary from the solution obtained during the polymerization or from the aqueous dispersion.

The components here may be metered in together or separately/in succession. The modulus of elasticity Eₜ of the substrate layer (measured to ISO 527-2/1B at 5 mm/min at a temperature of 100° C.) is preferably at least 1000 MPa.

### Layer (2)

Layer (2) is a colored intermediate layer which may preferably comprise special-effect pigments, such as metal flakes or mica. Layer (2) differs from layers (1) and (3), for example because its polymeric composition differs from these and/or because its additive contents, such as colorants or special-effect pigments, differ from these. One embodiment of the invention provides a molding comprising a composite layered sheet or composite layered film composed of a substrate layer (1) as described above, a top layer (3), and an intermediate layer (2) located between these and constituted of aliphatic thermoplastic polyurethane, of impact-resistant PMMA, of polycarbonate or of styrene (co)polymers, such as SAN, which may have been impact-modified, for example ASA or ABS, or a mixture of these polymers, with the proviso that the constitution or composition of layer (2) is not identical with that of either layer (1) or layer (3). If aliphatic thermoplastic polyurethane is used as material of the intermediate layer (2), use may be made of the aliphatic thermoplastic polyurethane described under layer (3). If polycarbonate is used as intermediate layer (2), use may be made of the polycarbonate described under layer (1), component C.

Impact-resistant PMMA (high impact PMMA: HI PMMA) is a polymethyl methacrylate which has been rendered impact-resistant via suitable additives. Examples of suitable impact-modified PMMAs are described by M. Stickler, T. Rhein in Ullmann's encyclopedia of industrial chemistry Vol. A21, pp. 473-486, VCH Publishers Weinheim, 1992, and H. Domininghaus, Die Kunststoffe und ihre Eigenschaften [Plastics and their properties], VDI-Verlag Düsseldorf, 1992. The intermediate layer (2) comprises colorants known to the person skilled in the art. Examples of these are dyes or pigments. These dyes or pigments may be organic or inorganic compounds.

### Layer (3)

Any aliphatic thermoplastic polyurethane is generally suitable for forming the top layer (3) of the inventive moldings, and preference is given to amorphic aliphatic thermoplastic polyurethanes which are transparent. Aliphatic thermoplastic polyurethanes and their preparation are known to the person skilled in the art, for example from EP-B1 567 883 or DE 10321081.4 (file reference), and are commercially available, for example with the trademarks Texin® and Desmopan® from Bayer Aktiengesellschaft.

Preferred aliphatic thermoplastic polyurethanes have a Shore D hardness of from 45 to 70.

The surface gloss of the top layer (3) measured to DIN 67530 at observation angles of both 200 and 600 is preferably above 80 units.

The layer thickness of the above composite layered sheets or composite layered films is preferably from 110 μm to 2.8 mm.

In one preferred embodiment of the invention, the composited layered sheets or composite layered films are composed of a substrate layer (1) and of a top layer (3) with the following layer thicknesses: substrate layer (1) from 50 μm to 1.5 mm; top layer (3) from 10 to 500 μm.

In another preferred embodiment of the invention, the composite layered sheets or composite layered films are composed of a substrate layer (1), of an intermediate layer (2), and of a top layer (3). Composite layered sheets or composite layered films composed of a substrate layer (1), of an intermediate layer (2), and of a top layer (3) preferably have the following layer thicknesses: substrate layer (1) from 50 μm to 1.5 mm; intermediate layer (2) from 50 to 500 μm; top layer (3) from 10 to 500 μm.

In one preferred embodiment, the material forming the substrate layer (1) of the composite layered sheets or composite layered films present in the moldings of the invention has a Vicat softening point (Vicat B measured to DIN 53 460 with a temperature rise of 50 K/h) of at least 105° C., preferably at least 108° C. In one preferred embodiment, the composite layered sheets or composite layered films present in the moldings of the invention have a modulus of elasticity Eₜ (measured to ISO 527-2/1B at 5 mm/min and 90° C.) of at least 1300 MPa, preferably at least 1400 MPa, and a modulus of elasticity Eₜ (measured to ISO 527-2/1B at 5 mm/min and 100° C.) of at least 900 MPa, preferably at least 950 MPa, and a Shore C hardness (measured to DIN 53505 at 90° C.) of at least 70, preferably at least 80, particularly preferably at least 90, very particularly preferably at least 100, and a Shore C hardness (measured to DIN 53505 at 100° C.) of at least 60, preferably at least 70, particularly preferably at least 80, very particularly preferably at least 90.

Three-layer sheets or three-layer films may be produced, for example, from a composite layered film with 2 layers (2) and (3), by providing these with a substrate layer (1). They may be produced by the process known to the skilled worker, in particular by the adapter coextrusion method described below. It is advantageous here for the ratio of the magnitude of the MFI (melt flow index) values of the individual layers of the composite layered sheets or composite layered films to be not more than 3:1, particularly preferably not more than 2:1. This means that the greatest MFI value of one of the layers (1), (2), and (3), to the extent that they are present in the particular composite layered sheets or composite layered films, is not more than three times, particularly preferably not more than twice, the lowest MFI value. This ensures uniform flow behavior of all of the components used in the composite layered sheets or composite layered films. This mutually balanced flow behavior is particularly advantageous in the production processes of adapter coextrusion described below.

There may be other layers present in the moldings of the invention between backing layer and composite layered sheet or composite layered film. By way of example, the inventive moldings may have an adhesion-promoter layer on that side of the substrate layer (1) facing away from the top layer (3). These adhesion promoter layers are preferably produced from a material compatible with polyolefins, e.g. SEBS (styrene-ethylene-butadiene-styrene copolymer, e.g. marketed with the trademark Kraton®). If this type of adhesion-promoter layer is present its thickness is preferably from 10 to 300 μm.

### Production Process for Composite Layered Sheets or Composite Layered Films

The composite layered sheets or composite layered films of the moldings of the invention may be produced by known processes, for example by adapter extrusion or coextrusion, or mutually superposed lamination of the layers. The individual components here are rendered flowable in extruders and, by way of specific apparatus, brought into contact with one another in such a way as to give the composite layered sheets or composite layered films with the layer sequence described above. For example, the components may be coextruded through a slot die. This process is explained in EP-A2-0 225 500.

They may also be produced by the adapter coextrusion process, as described in Tagungsband der Fachtagung Extrusionstechnik “Coextrusion von Folien” [Proceedings of the conference on extrusion technology, “Coextrusion of films”], Oct. 8/9, 1996, VDI-Verlag Dusseldorf, in particular a contribution from Dr. Netze. This cost-effective process is used in most coextrusion applications.

The composite layered sheets and composite layered films of the invention may also be produced by mutually superposed lamination of films or sheets of the components in a heatable nip. Here, films or sheets of the individual components are first produced. Known processes can be used for this purpose. The desired layer sequence is then produced by appropriate mutual superposition of the films or sheets, and these are then passed through a heatable nip between rolls, and bonded with exposure to pressure and heat to give a composite layered sheet or composite layered film.

In particular for the adapter coextrusion process, it is advantageous to balance the flow properties of the individual components in order to develop uniform layers in the composite layered sheets or composite layered films.

### Processes for Producing the Moldings of the Invention

The composite layered sheets or composite layered films may be used to produce moldings, thus giving desired moldings. The composite layered sheets or composite layered films are particularly preferably used to produce moldings in which very good surface properties are important, in particular gloss properties. The surfaces are also very scratch-resistant and firmly bonded, giving reliable prevention of destruction of the surfaces by scratching or peeling. The preferred application sector is therefore moldings for outdoor use, for example the exterior of buildings. In particular, the composite layered sheets or composite layered films are used to produce motor vehicle components, specifically motor vehicle components for exterior applications in the motor vehicle sector. Examples of possible uses here are the production of roof modules, engine covers, wheel surrounds, door leaves, bumpers, tailgate panels, or else other large-surface-area exterior parts.

Known processes can be used to produce moldings of the invention from the composite layered sheets or composite layered films. The composite layered sheets or composite layered films may be reverse-coated by an injection-molding, foaming, casting, or compression-molding method, without using any other stage in the process. In particular, the use of the composite layered sheets or composite layered films described even permits the production of components with slightly three-dimensional character without prior thermoforming, because of the marked improvement in tensile strain at break (over films coextruded using PMMA or SAN as top layer). However, the composite layered sheets or composite layered films may also be subjected to a prior thermoforming process. For example, composite layered sheets or composite layered films with the three-layer structure made from substrate layer, intermediate layer, and top layer, or with the two-layer structure made from substrate layer and top layer, can be shaped by thermoforming to produce relativey complex moldings. Use may be made here of either positive or negative thermoforming processes. These processes are known to the skilled worker. This thermoforming process stretches the composite layered sheets or composite layered films. The gloss or surface quality of the composite layered sheets or composite layered films does not decrease with stretching at high stretching ratios, for example up to 1:5, and thermoforming processes are therefore not subject to any major restrictions with regard to the amount of stretching which can be achieved.

The moldings of the invention can be produced from the composite layered sheets or composite layered films, if appropriate after a thermoforming process, by injection molding, foaming, or casting material onto the back of the sheets or films. These processes are known to the skilled worker and are described by way of example in DE-A1 100 55 190 or DE-A1 199 39 111.

The moldings of the invention are obtained by the injection-molding, foaming, casting or compression-molding of a plastic onto the back of the composite layered films. The plastics used for the process of injection-molding, compression-molding or casting onto the back of the material preferably comprise thermoplastic molding compositions based on ASA polymers or on ABS polymers, on SAN polymers, on poly(meth)acrylates, on polyether sulfones, on polybutylene terephthalate, on polycarbonates, on polypropylene (PP), or on polyethylene (PE), and blends made from ASA polymers or ABS polymers and polycarbonates, or polybutylene terephthalate, and blends made from polycarbonates and polybutylene terephthalate. Clearly, if PE and/or PP is used here, the substrate layer may be provided in advance with an adhesive layer. Amorphous thermoplastics or blends of these are particularly suitable. The plastic used for injection-molding onto the back of the material preferably comprises ABS polymers or SAN polymers. In another preferred embodiment, thermoset molding compositions known to the person skilled in the art are used for foaming and compression-molding onto the back of the material. In one preferred embodiment, these are glass-fiber-reinforced plastics, and in particular DE-A1 100 55 190 describes suitable variants. For foaming onto the back of the material it is preferable to use polyurethane foams, for example those described in DE-A1 199 39 111.

One preferred process for producing the inventive moldings comprises thermoforming the composite layered sheet or composite layered film, and then inserting it into a reverse-coating mold, and then reverse-coating with thermoplastic molding compositions, using an injection-molding, casting, or compression-molding method, or reverse-coating with thermoset molding compositions, using a foaming or compression-molding method.

After the thermoforming and prior to the insertion into the reverse-coating mold, the composite layered sheet or composite layered film may undergo a profile-cut process. The profile-cut process may also be delayed until after removal from the reverse-coating mold.

The invention is described below in more detail, using examples.

Comparative examples of the prior art:

Multilayer films constituted as follows, produced by adapter coextrusion, were studied:
1. Transparent top layer 80 μm (layer thickness) composed of Plexiglass® 7M (PMMA) from Röhm GmbH on 920 μm (layer thickness) black-colored Luran® S 778TE (ASA) from BASF Aktiengesellschaft
2. Transparent top layer 80 μm (layer thickness) composed of Lurane® KR2556 (SAN) from BASF Aktiengesellschaft on 920 μm (layer thickness) black-colored Luran® S 778TE (ASA) from BASF Aktiengesellschaft
3. Transparent top layer composed of Lexane® SLX (modified PC) from GE Plastics on a black-colored backing composed of Lexane® (PC) from GE Plastics, total thickness 1.3 mm

Examples of production of composite layered films for inventive moldings:

The substrate layer used comprises an ASA polymer with an SAN hard phase composed of Luran® KR2556 from BASF Aktiengesellschaft, and with rubber content (acrylate rubber with 500 nm particle diameter) of 50%. Compared with other commercially available ASA polymers (e.g. Lurane® S 778TE from BASF Aktiengesellschaft), this product has improved heat resistance.

The top layer used comprised a transparent aliphatic TPU (Texin® DP7-3007 from Bayer Polymers).

Because the flow properties of the two polymers are very different (processing temperature: ASA 240-260° C.; TPU 160-180° C.), adapter coextrusion cannot be used to produce a composite. The procedure selected was therefore as follows:

First, the ASA polymer was used to produce a black-colored monofilm of thickness 1.0 mm. In a second step of the process, the TPU was applied to the substrate layer by the process known as extrusion coating. For this, the TPU was predried at 60° C. to a residual moisture level below 0.05%, and was melted at from 150 to 180° C. extruder temperature, and discharged through a slot die. The substrate layer composed of ASA was fed to the downstream polishing stack, so that the TPU melt emerging from the slot die was extruded onto the ASA film, and was polished on the cooled rollers, and solidified.

The composite layered film for the inventive moldings had the following constitution:
4. 80 μm (layer thickness) of transparent, aliphatic TPU on 1.0 mm (layer thickness) of black-colored ASA.

The surface gloss of all of the specimens was then measured to DIN 67530 at observation angles of 20° and 60°. The specimens were then subjected to two different scratch tests:
1. Scratch resistance in what is known as the Micro Scratch test: The surfaces were scratched using a defined applied load and a diamond needle (tip angle 120°, radius 0.2 mm). The resultant scratch depths were measured immediately after scratching, after 24 h of storage at 23° C., and also after further storage (“reflow”) for an hour at 60° C.
2. Wash-bay simulation based on Peugeot standard PSA D45 1010, but is exacerbated by using a Vileda bath cleaner (household wiper with a green, very rough surface on one side) as abrader instead of the linen cloth prescribed in the test standard. The scratching procedure (10 cycles) was carried out both in the dry state and with solvents (soapy water). Assessment was made of measured surface gloss immediately after scratching, after 24 h of storage at 23° C., and also after further storage (“reflow”) for an hour at 60° C.

### Results of 1.:

| | | F = 1.4 N | F = 1.4 N |
|---|---|---|---|
| | F = | after | after 1 h |
| Top layer/scratch depth in μm | 1.4 N | 24 h | at 60° C. |
| 1. Lucryl G87E (PMMA) comparison | 0 | 0 | 0 |
| 2. Luran KR2556 (SAN) comparison | 0.63 | 0.59 | 0.55 |
| 3. Lexan SLX (modif. PC) comparison | 1.15 | 1.02 | 0.92 |
| 4. Inventive film (TPU) | 0.63 | 0.2 | 0 |
| | | F = 2.6 N | F = 2.6 N |
| | F = | after | after 1 h |
| Top layer/scratch depth in μm | 2.6 N | 24 h | at 60° C. |
| 1. Lucryl G87E (PMMA) comparison | 0.45 | 0.37 | 0.37 |
| 2. Luran KR2556 (SAN) comparison | 2.06 | 1.98 | 1.92 |
| 3. Lexan SLX (modif. PC) comparison | 2.76 | 2.5 | 2.26 |
| 4. Inventive film (TPU) | 1.18 | 0.37 | 0.12 |

Penetration depth is clearly seen to increase as the hardness of the top layer material reduces (from PMMA via SAN to PC). Despite low surface hardness, the film for the inventive moldings exhibits moderate penetration depths immediately after scratching, and this reduced to zero or near-zero after one day or after storage at 60° C.

### Results of 2.:

PSA D45 1010 using Vileda bath wiper (dry)

| | | | after | after 1 h |
|---|---|---|---|---|
| Gloss level 20°/60° | Initial gloss | immediate | 24 h | at 60° C. |
| 1. Lucryl G87E (PMMA) | 79/87 | 28/58 | | |
| comparison | | | | |
| 2. Luran KR2556 (SAN) | 99/100 | 49/71 | | |
| comparison | | | | |
| 3. Lexan SLX | 115/108 | 73/91 | | |
| (modif. PC) | | | | |
| comparison | | | | |
| 4. Inventive film (TPU) | 77/95 | 78/109 | 77/107 | 104/121 |

PSA D45 1010 using Vileda bath winer (soapy water)

| | | | after | after 1 h |
|---|---|---|---|---|
| Gloss level 20°/60° | Initial gloss | immediate | 24 h | at 60° C. |
| 1. Lucryl G87E (PMMA) | 79/87 | 56/79 | | |
| comparison | | | | |
| 2. Luran KR2556 (SAN) | 99/100 | 57/77 | | |
| comparison | | | | |
| 3. Lexan SLX (modif. | 115/108 | 50/77 | | |
| PC) comparison | | | | |
| 4. Inventive film (TPU) | 77/95 | 71/100 | 68/97 | 87/109 |

In contrast to the comparative examples, there was hardly any loss of gloss from the film for the inventive moldings, and in particular after reflow (1 h at 60° C.), the gloss values were indeed outstandingly actually higher. The comparative examples exhibited no effect of storage on gloss after scratching.

A monofilm composed of a TPU (Texin® DP7-3007 from Bayer Polymers) of thickness 200 μm studied for comparison exhibited very irreproducible gloss values even prior to scratching: from 20 to 75. No gloss change after scratching could be documented for this film.

The examples confirm that, when compared with known moldings, the inventive moldings exhibit improved surface gloss over their service life, in particular in association with frequent soiling and the resultant necessary cleaning in automatic washing systems.

1. A molding comprising a composite layered sheet or composite layered film, reverse-coated with a backing layer of plastic applied by an injection-molding, foaming, casting, or compression-molding method, where the composite layered sheet or composite layered film comprises
(1) a substrate layer comprising, based on the total of the amounts of components A and B, and, if appropriate, C and/or D, which give 100% by weight in total,
a from 1 to 99% by weight of an elastomeric graft copolymer as component A,
b from 1 to 99% by weight of one or more hard copolymers containing units which derive from vinylaromatic monomers, as component B,
c from 0 to 80% by weight of polycarbonates, as component C, and
d from 0 to 50% by weight of fibrous or particulate fillers, or a mixture of these, as component D, and
(3) a top layer comprising an aliphatic thermoplastic polyurethane.

2. The molding according to claim 1, wherein the thickness of the top layer (3) is from 10 to 500 μm and the thickness of the substrate layer (1) is from 50 to 1500 μm.

3. The molding according to claim 1, wherein the modulus of elasticity Eₜ (measured to ISO 527-2/1B at 5 mm/min at a temperature of 100° C.) of the substrate layer (1) is at least 1000 MPa.

4. The molding according to claim 1, wherein, between the top layer (3) and the substrate layer (1) there is a colored intermediate layer (2) comprising aliphatic thermoplastic polyurethane, impact-modified polymethyl methacrylate, polycarbonate, or styrene (co)polymers.

5. The molding according to claim 4, wherein the thickness of the intermediate layer (2) is from 50 to 500 μm.

6. The molding according to claim 1, wherein there is an adhesion promoter layer on that side of the substrate layer (1) facing away from the top layer (3).

7. The molding according to claim 6, wherein the thickness of the adhesion promoter layer is from 10 to 300 μm.

8. The molding according to claim 1, wherein the layer thickness of the composite layered sheet or composite layered film is from 110 μm to 2.8 mm.

9. The molding according to claim 1, wherein the surface gloss of the top layer (3) measured to DIN 67530 at observation angles of both 20° and 60° is above 80 units.

10. The molding according to claim 1, wherein the aliphatic thermoplastic polyurethane present in the top layer (3) has a Shore D hardness of from 45 to 70.

11. The molding according to claim 1, wherein component B contains, based on the total weight of units derived from vinylaromatic monomers, from 40 to 100% by weight of units derived from α-methylstyrene and from 0 to 60% by weight of units derived from styrene.

12. The molding according to claim 1, wherein component A comprises
a1 from 1 to 99% by weight of a particulate graft base as component A1, obtainable by polymerizing, based on A1,
a11 from 80 to 99.99% by weight of at least one C₁-C₈-alkyl acrylate, as component A11,
a12 from 0.01 to 20% by weight of at least one polyfunctional crosslinking monomer, as component A12,
a2 from 1 to 99% by weight of a graft A2 obtainable by polymerizing, based on A2,
a21 from 40 to 100% by weight of styrene, of a substituted styrene, or of a (meth)acrylate, or of a mixture of these, as component A21, and
a22 up to 60% by weight of acrylonitrile or methacrylonitrile, as component A22,
where the graft A2 is composed of at least one graft shell, and the graft copolymer has a median particle size of from 50 to 1000 nm,
and component B comprises copolymers of
b1 from 40 to 100% by weight of vinylaromatic monomers, as component B1,
b2 up to 60% by weight of acrylonitrile or methacrylonitrile, as component B2.

13. The molding according to claim 1, wherein component A comprises
a1′ from 10 to 90% by weight of at least one elastomeric graft base with a glass transition temperature below 0° C., as component A1′, obtainable by polymerizing, based on A1′,
a11′ from 60 to 100% by weight of at least one conjugated diene, as component A11′,
a12′ from 0 to 30% by weight of at least one monoethylenically unsaturated monomer, as component A12′, and
a13′ from 0 to 10% by weight of at least one crosslinking monomer having unconjugated double bonds, as component A13′,
a2′ from 10 to 60% by weight of a graft, as component A2′, made from, based on A2′,
a21′ from 50 to 100% by weight of at least one vinylaromatic monomer, as component A21′,
a22′ from 5 to 35% by weight of acrylonitrile and/or methacrylonitrile, as component A22′,
a23′ from 0 to 50% by weight of at least one other monoethylenically unsaturated monomer, as component A23′,
and component B comprises copolymers of
b1′ from 50 to 100% by weight of vinylaromatic monomers, as component B1′,
b2′ from 0 to 50% by weight of acrylonitrile or methacrylonitrile or a mixture of these, as component B2′,
b3′ from 0 to 50% by weight of at least one other monoethylenically unsaturated monomer, as component B3′.

14. The molding according to claim 1, wherein the backing layer comprises glass fibers or other reinforcing fibers.

15. A process for producing a molding according to claim 1, which comprises irreversibly bonding all of the layers of the composite layered sheet or composite layered film to one another in the molten state in a coextrusion process.

16. The process according to claim 15, wherein the layers are brought together in an adaptor die or in a coextrusion die.

17. A process for producing a molding according to claim 1, which comprises irreversibly bonding one or more layers of the composite layered sheet or composite layered film in a laminating process in a heated nip.

18. A process for producing a molding according to claim 1, which comprises thermoforming the composite layered sheet or composite layered film, and then inserting it into a reverse-coating mold, and then reverse-coating with thermoplastic molding compositions, using an injection-molding, casting, or compression-molding method, or reverse-coating with thermoset molding compositions, using a foaming or compression-molding method.

19. The process according to claim 18, wherein, prior to insertion into the reverse-coating mold, the composite layered sheet or composite layered film undergoes a profile-cut process.

20. The process according to claim 18, wherein, after removal from the reverse-coating mold, the composite layered sheet or composite layered film undergoes a profile-cut process.

21. The use of the moldings according to claim 1, for application in the motor vehicles exterior sector, in particular for roof modules, engine hoods, wheel surrounds, bumpers, door leaves, tailgate panels, and other large-surface-area exterior parts.

22. A motor-vehicle-exterior part, in particular roof modules, engine hoods, wheel surrounds, bumpers, door leaves, and tailgate panels, comprising moldings according to claim 1.
